(19) United States
(12) Patent Application Publication
(10) Pub. No.: US 2018/0286263 A1
(43) Pub. Date: Oct. 4, 2018

(54) IMAGE READING DEVICE AND IMAGE FORMING APPARATUS

(71) Applicant: KYOCERA Document Solutions Inc., Osaka (JP)

(72) Inventor: Atsushi SUZUKI, Osaka-shi (JP)

(73) Assignee: KYOCERA Document Solutions Inc., Osaka (JP)

(21) Appl. No.: 15/939,867

(22) Filed: Mar. 29, 2018

(30) Foreign Application Priority Data
Mar. 30, 2017 (JP) 2017-067141

(51) Int. Cl. G09B 7/06; G06K 9/00

(52) U.S. Cl. CPC G09B 7/06; G06K 2009/00489; G06K 9/00469

(57) ABSTRACT

An image forming apparatus includes a controller. The controller includes a reading section, a character recognition section, a marking section, and a notification section. The reading section reads an image from a document on which an answer to a problem is entered and generates image information. The character recognition section performs character recognition processing on the image information, and generates text data corresponding to the answer. The marking section marks the answer on the basis of the text data. When the text data cannot be generated through the character recognition processing, the notification section notifies a smartphone that the answer cannot be marked.

### INCORPORATION BY REFERENCE

The present application claims priority under 35 U.S.C. § 119 to Japanese Patent Application No. 2017-067141, filed on Mar. 30, 2017. The contents of this application are incorporated herein by reference in their entirety.

### BACKGROUND

The present disclosure relates to an image reading device and an image forming apparatus.

Some image processing device includes an image reading means, an image storing means, a problem recognition means, an answer recognition means, a correct answer retaining means, and a marking means. The image reading means reads an image from an answer sheet and generates image information. The image storing means stores the image information therein. The problem recognition means recognizes a problem from the image information. The correct answer retaining means retains a correct answer to the problem recognized by the problem recognition means. The answer recognition means recognizes one or more characters, symbols, or marks included in an answer to the problem. The marking means marks the answer through comparison between the answer and the correct answer.

### SUMMARY

An image reading device of the present disclosure includes a reading section, a character recognition section, a marking section, and a notification section. The reading section reads an image from a document on which an answer to a problem is entered and generates image information. The character recognition section performs character recognition processing on the image information and generates text data corresponding to the answer. The marking section marks the answer on the basis of the text data. When the text data cannot be generated through the character recognition processing, the notification section notifies a specific terminal device that the answer cannot be marked.

An image forming apparatus of the present disclosure includes a reading section, a character recognition section, a marking section, a notification section, and an image forming device. The reading section reads an image from a document on which an answer to a problem is entered, and generates image information. The character recognition section performs character recognition processing on the image information and generates text data corresponding to the answer. The marking section marks the answer on the basis of the text data. When the text data cannot be generated through the character recognition processing, the notification section notifies a specific terminal device that the answer cannot be marked. The image forming device forms an image on a recording medium.

### BRIEF DESCRIPTION OF THE DRAWINGS

FIG. 1 is a diagram illustrating a state of connection of an image forming apparatus according to an embodiment of the present disclosure.

FIG. 2 is a perspective view illustrating a configuration of the image forming apparatus according to the embodiment of the present disclosure.

FIG. 3 is a diagram illustrating a configuration of a controller according to the embodiment of the present disclosure.

FIG. 4 is a diagram illustrating an example of problem information stored in a server.

FIG. 5 is a diagram illustrating an example of an answer sheet.

FIG. 6 is a screen diagram illustrating an example of a notification screen displayed in a smartphone.

FIG. 7 is a screen diagram illustrating a notification screen other than that illustrated in FIG. 6.

FIG. 8 is a screen diagram illustrating a notification screen other than those illustrated in FIGS. 6 and 7.

FIG. 9 is a flowchart illustrating an example of processing performed by the controller.

FIG. 10 is a flowchart illustrating an example of inquiry processing performed by the controller.

FIG. 11 is a flowchart illustrating an example of problem generation processing performed by the controller.

### DETAILED DESCRIPTION

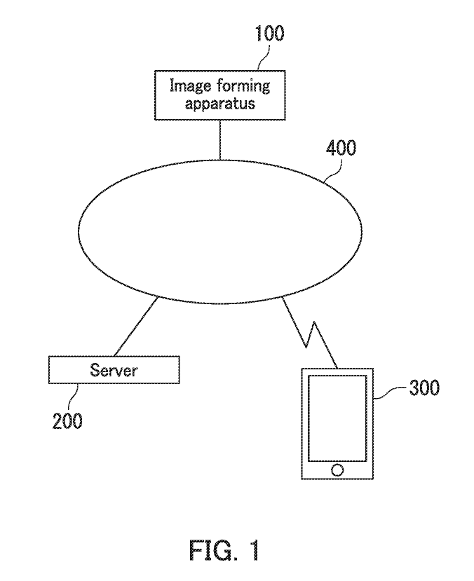

The following describes an embodiment of the present disclosure with reference to the drawings (FIGS. 1 to 11). In the drawings, elements that are the same or equivalent are labelled using the same reference signs, and explanation of which will not be repeated.

First, a state of connection of an image forming apparatus 100 according to the embodiment of the present disclosure will be described with reference to FIG I. As illustrated in FIG. 1, the image forming apparatus 100 is communicatively connected to a server 200 and a smartphone 300 via a network 400.

The image forming apparatus 100 is generally called a multifunction peripheral and has a communication function. The image forming apparatus 100 transmits to and receives from the server 200 various information via the network 400.

The server 200 is generally called a data server and stores various information therein. The server 200 transmits various information to the image forming apparatus 100 in response to a request from the image forming apparatus 100. Also, the server 200 stores therein various information transmitted from the image forming apparatus 100.

The smartphone 300 has a wireless communication function. The smartphone 300 is an example of a “specific terminal device”. The smartphone 300 receives inquiry information from the image forming apparatus 100. The smartphone 300 transmits to the image forming apparatus 100 reply information input to the smartphone 300. The smartphone 300 is used for example by a school teacher.

The network 400 is for example the Internet. The network 400 is not limited to the Internet. The network 400 may be a local area network (LAN) or a wide area network (WAN).

Although the “specific terminal device” in the embodiment of the present disclosure is the smartphone 300 as described above with reference to FIG. 1, the present disclosure is not limited thereto. It is only required that the “specific terminal device” is communicatively connected to the image forming apparatus 100. The “specific terminal device” may be for example a personal computer or a tablet terminal device.

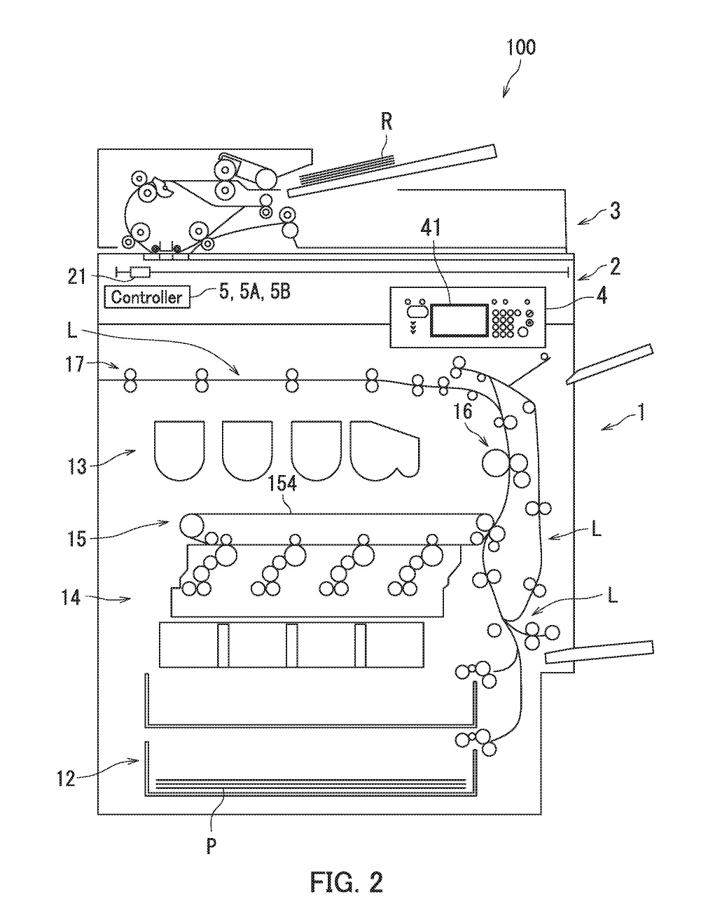

The following describes a configuration of the image forming apparatus 100 according to the present embodiment with reference to FIGS. 1 and 2. FIG. 2 is a diagram illustrating the configuration of the image forming apparatus 100. The image forming apparatus 100 is a color multifunction peripheral. The image forming apparatus 100 reads an image from a document R and forms the image on paper P using toner.

As illustrated in FIG. 2, the image forming apparatus 100 includes an image forming unit 1, a document reader 2, a document conveyance unit 3, an operation display section 4, and a controller 5. The image forming unit I forms an image on paper P. The document reader 2 reads an image from the document R and generates image information. The document conveyance unit 3 conveys the document R to the document reader 2. The controller 5 controls operation of the image forming apparatus 100. The document reader 2 and the controller 5 constitute an “image reading device”. The image forming unit 1 is a part of an “image forming device”.

The image forming unit 1 includes a feeding section 12, a conveyance section L, a toner supply section 13, a formation execution section 14, a fixing section 16, and an ejection section 17. The formation execution section 14 includes a transfer section 15.

The feeding section 12 supplies paper P to the conveyance section L. The conveyance section L conveys the paper P to the ejection section 17 via the transfer section 15 and the fixing section 16. The paper P is an example of a “recording medium”.

The toner supply section 13 supplies toner to the formation execution section 14. The formation execution section 14 forms the image on the paper P.

The transfer section 15 includes an intermediate transfer belt 154. The formation execution section 14 transfers toner images in respective colors of cyan, magenta, yellow, and black onto the intermediate transfer belt 154. The toner images in the respective colors are superimposed on one another on the intermediate transfer belt 154, whereby an image is formed on the intermediate transfer belt 154. The transfer section 15 transfers the image formed on the intermediate transfer belt 154 to the paper P. Through the above, an image is formed on the paper P.

The fixing section 16 fixes to the paper P the image formed on the paper P through application of heat and pressure to the paper P. The ejection section 17 ejects the paper P out of the image forming apparatus 100.

The document reader 2 includes an image reading section 21. The image reading section 21 is a contact image sensor (CIS) unit as an integrated assembly of a light emitting diode (LED), contact glass, an imaging lens, and an image sensor.

The operation display section 4 receives a user operation. The operation display section 4 includes a touch panel 41. The touch panel 41 includes for example a liquid crystal display (LCD) and displays various images. The touch panel 41 further includes a touch sensor and receives the user operation.

The controller 5 includes a processor 5A and storage 5B. The processor 5A includes for example a central processing unit (CPU). The storage 5B includes memory such as semiconductor memory, and may include a hard disk drive (HDD). The storage 5B stores therein a control program.

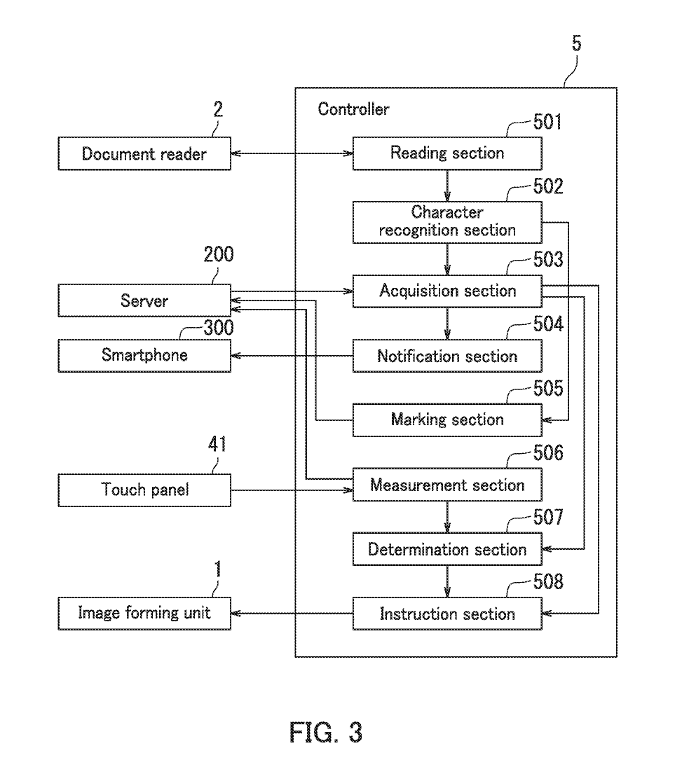

The following describes a configuration of the controller 5 according to the embodiment of the present disclosure with reference to FIGS. 1 to 3. FIG. 3 is a diagram illustrating the configuration of the controller 5.

As illustrated in FIG. 3, the controller 5 includes a reading section 501, a character recognition section 502, an acquisition section 503, a notification section 504, a marking section 505, a measurement section 506, a determination section 507, and an instruction section 508. Specifically, through execution of the control program, the processor SA functions as the reading section 501, the character recognition section 502, the acquisition section 503, the notification section 504, the marking section 505, the measurement section 506, the determination section 507, and the instruction section 508.

The reading section 501 reads an image from the document R and generates image information MJ. Specifically, the reading section 501 reads the image from the document R through the document reader 2 and generates the image information MJ. An answer AN to a problem PR is entered on the document R. The reading section 501 generates image information MJ indicating an answer image MA. The answer image MA is an image of the answer AN.

The character recognition section 502 performs character recognition processing on the image information MJ and generates text data ANJ corresponding to the answer AN. The character recognition processing is optical character recognition (OCR) processing.

The acquisition section 503 acquires problem information PRJ from the server 200. Specifically, the acquisition section 503 acquires the problem information PRJ from the server 200 on the basis of problem identification information PID. The problem identification information PID is information for identifying the problem PR. The problem information PRJ indicates the problem PR. The acquisition section 503 is an example of a “first acquisition section”.

The acquisition section 503 also acquires from the server 200 problem information PRJ indicating a problem PR that belongs to a not well-understood field. The “not well-understood field” is a field at which an answerer is not good or in which the answerer does not understand well. The acquisition section 503 is an example of a “third acquisition section”.

When the text data ANJ cannot be generated through the character recognition processing, the notification section 504 notifies the smartphone 300 that the answer AN cannot be marked correct or incorrect. Also, the notification section 504 transmits the problem information PRJ and suggested answer information ASJ to the smartphone 300.

The marking section 505 marks the answer AN on the basis of the text data ANJ.

The measurement section 506 measures an answer period ANT that indicates a period of time from when the answerer starts making the answer AN to when the answerer finishes making the answer AN. The measurement section 506 for example measures the answer period ANT on the basis of a user operation on the touch panel 41. Specifically, the user inputs through the touch panel 41 a time when the answerer starts making the answer AN and a time when the answerer finishes making the answer AN. The measurement section 506 measures the answer period ANT on the basis of the input times of the start and finish of the answer AN.

The determination section 507 determines a well-understood field and the not well-understood field of the answerer on the basis of the answer period ANT and a correct answer rate CR. The “well-understood field” is a field at which the answerer is good or in which the answerer understands well. The correct answer rate CR indicates a probability that the answer AN is correct.

The instruction section 508 instructs the image forming unit 1 to form on the paper P a problem image MPR representing the problem information PRJ acquired by the acquisition section 503. The instruction section 508 is a part of the “image forming device”.

As described above with reference to FIGS. 1 to 3, when the text data ANJ corresponding to the answer AN entered on the document R cannot be generated, the notification section 504 notifies the smartphone 300 that the answer AN cannot be marked in the embodiment of the present disclosure. Therefore, for example, a user of the smartphone 300 can determine whether the answer AN is correct or incorrect and input a result of the determination to the image forming apparatus 100. Through the above, the answer AN can he marked even when the answer AN cannot be read through the character recognition processing.

Also, the measurement section 506 measures the answer period ANT and the determination section 507 determines whether the problem PR corresponding to the answer AN belongs to a well-understood field or a not well-understood field on the basis of the answer period ANT and the correct answer rate CR. Specifically, when the correct answer rate CR is smaller than a specific value, the determination section 507 determines that the problem PR belongs to a not well-understood field. Even when the correct answer rate CR is equal to or larger than the specific value, the determination section 507 determines that the problem PR belongs to a not well-understood field as long as the answer period ANT is equal to or longer than a specific period. Therefore, whether the problem PR belongs to a well-understood field or a not well-understood field can he properly determined.

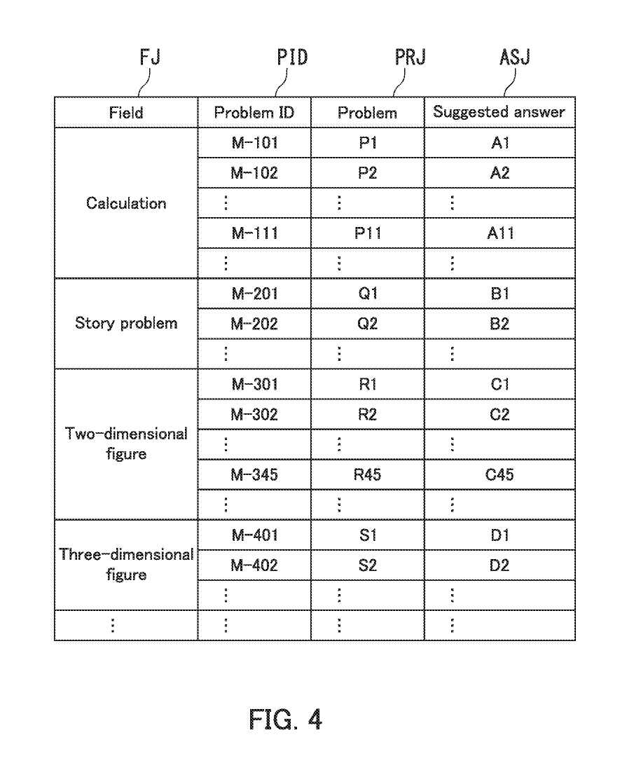

The following describes the problem information PRJ stored in the server 200 with reference to FIGS. 1 to 4. FIG. 4 is a diagram illustrating an example of the problem information PRJ stored in the server 200.

As illustrated in FIG. 4, the problem information PRJ is stored in the server 200 in association with field information FJ, the problem identification information PID, and the suggested answer information ASJ. The embodiment of the present disclosure describes a case where the problem PR is a mathematical problem.

The field information FJ indicates a mathematical field. For example, the field information FJ indicates for example a field of calculation, story problem, two-dimensional figure, or three-dimensional figure.

The problem identification information PID is information for identifying the problem PR. The problem identification information PID in the embodiment of the present disclosure includes an alphabetic character “M” that indicates that the subject is mathematics, and a three-digit number. Identification codes such as “M-101” and “M-102” are for example assigned to calculation problems PR. Also, identification codes such as “M-301” and “M-302” are for example assigned to problems PR about two-dimensional figures.

The problem information PRJ is text information indicating the problem PR. For example, the problem information PRJ associated with the problem identification information PID to which “M-101” is assigned is “P1”. Also, the problem information PRJ associated with the problem identification information PID to which “M-302” is assigned is “R2”.

The suggested answer information ASJ is text information indicating a suggested answer AS to the problem PR. For example, the suggested answer information ASJ associated with the problem identification information PID to which “M-101” is assigned is “A1”. Also, the suggested answer information ASJ associated with the problem identification information PID to which “M-302” is assigned is “C2”.

As described above with reference to FIGS. 1 to 4, the server 200 stores therein the problem information PRJ and the suggested answer information ASJ in association with the problem identification information PID in the embodiment of the present disclosure. Therefore, the problem information PRJ and the suggested answer information ASJ associated with the problem identification information PID can be easily acquired by transmitting the problem identification information PID to the server 200.

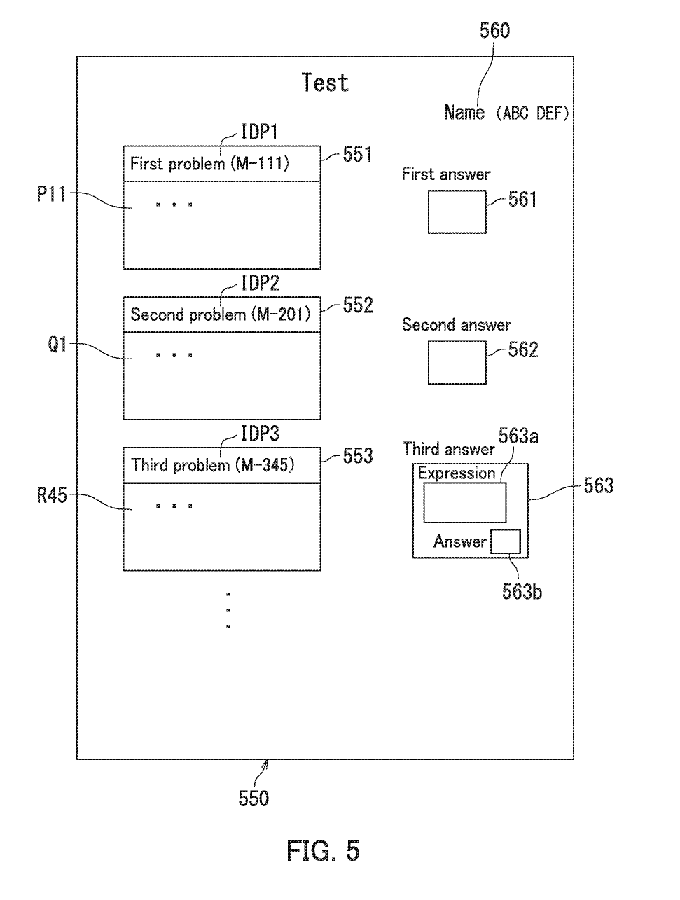

The following describes an example of an answer sheet 550 with reference to FIGS. 1 to 5. FIG. 5 is a diagram illustrating the example of the answer sheet 550. As illustrated in FIG. 5, a first problem space 551, a second problem space 552, a third problem space 553, a first answer space 561, a second answer space 562, a third answer space 563, and a name space 560 are printed on the answer sheet 550.

A problem statement P11 and a problem identification code IDP1 of a first problem are printed in the first problem space 551. “M-111” is printed as the problem identification code IDP1 and indicates that the first problem is the 11^{th} problem PR among problems PR for which the field information FJ illustrated in FIG. 4 indicates “calculation”. The problem statement P11 represents problem information PRJ corresponding to the problem identification code IDP1.

A problem statement Q1 and a problem identification code IDP2 of the second problem are printed in the second problem space 552. “M-201” is printed as the problem identification code IDP2 and indicates that the second problem is the first problem PR among problems PR for which the field information FJ illustrated in FIG. 4 indicates “story problem”. The problem statement Q1 represents problem information PRJ corresponding to the problem identification code IDP2.

A problem statement R45 and a problem identification code IDP3 of the third problem are printed in the third problem space 553. “M-345” is printed as the problem identification code IDP3 and indicates that the third problem is the 45^{th} problem PR among problems PR for which the field information FJ illustrated in FIG. 4 indicates “two-dimensional figure”. The problem statement R45 represents problem information PRJ corresponding to the problem identification code IDP3.

An answerer writes in the first answer space 561 an answer AN to the problem statement P11 of the first problem printed in the first problem space 551. The answerer writes in the second answer space 562 an answer AN to the problem statement Q1 of the second problem printed in the second problem space 552.

An expression space 563a and an answer space 563b are printed in the third answer space 563. The answerer writes in the expression space 563a an expression that the answerer uses for getting an answer AN to the problem statement R45 of the third problem printed in the third problem space 553. The answerer writes in the answer space 563b the answer AN to the problem statement R45 of the third problem printed in the third problem space 553.

The answerer writes his or her name in the name space 560. The name of the answerer is equivalent to answerer identification information AID. The acquisition section 503 acquires the answerer identification information AID on the basis of image information of the name of the answerer entered in the name space 560.

As described above with reference to FIGS. 1 to 5, the problem identification codes IDP1 to IDP3 representing the problem identification information PID are printed on the answer sheet 550 in the embodiment of the present disclosure. Therefore, the acquisition section 503 can easily acquire the problem information PRJ and the suggested answer information ASJ from the server 200.

Specifically, the reading section 501 generates image information indicating the problem identification codes IDP1 to IDP3. Then, the character recognition section 502 performs the character recognition processing on the image information and generates text data indicating the problem identification information PID. Further, the acquisition section 503 transmits the problem identification information PID to the server 200 and receives from the server 200 the problem information PRJ and the suggested answer information ASJ associated with the problem identification information PID.

Also, the notification section 504 transmits to the smartphone 300 the problem information PRJ that the acquisition section 503 has acquired from the server 200 on the basis of the problem identification information PID. Therefore, it can be ensured that the problem information PRJ corresponding to the answer AN is transmitted to the smartphone 300.

Further, the notification section 504 transmits to the smartphone 300 the suggested answer information ASJ that the acquisition section 503 has acquired from the server 200 on the basis of the problem identification information PID. Therefore, it can be ensured that the suggested answer information ASJ corresponding to the answer AN is transmitted to the smartphone 300.

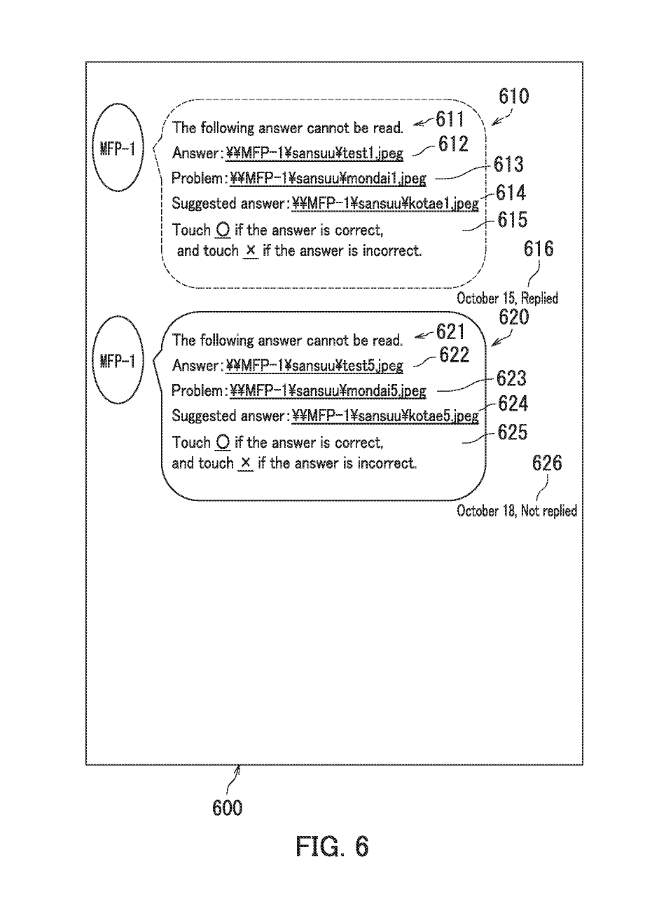

The following describes an example of a notification screen 600 displayed in the smartphone 300 with reference to FIGS. 1 to 6. FIG. 6 is a screen diagram illustrating the example of the notification screen 600 displayed on a touch panel of the smartphone 300. As illustrated in FIG. 6, the notification screen 600 includes a first display area 610 and a second display area 620.

The first display area 610 includes a first message display area 611, an answer link display area 612, a problem link display area 613, a suggested answer link display area 614, a second message display area 615, and a state display area 616.

The first message display area 611 displays a message for notifying the user of the smartphone 300 that an answer cannot be marked. Specifically, the following message “the following answer cannot be read” is displayed in the first message display area 611, indicating that text data corresponding to an answer image MA cannot be generated through the character recognition processing.

The answer link display area 612 displays an access destination for answer image information MAJ. The answer image information MAJ indicates the answer image MA of the answer AN of which text data cannot be generated through the character recognition processing. The access destination for the answer image information MAJ is equivalent to “first link information”. When the user touches the answer link display area 612, the smartphone 300 acquires the answer image information MAJ from the image forming apparatus 100 and displays the answer image MA on the touch panel.

Specifically, when the text data cannot be generated through the character recognition processing, the notification section 504 transmits to the smartphone 300 first link information LN1 that indicates the access destination for the answer image information MAJ. The smartphone 300 displays an image representing the first link information LN1 in the answer link display area 612.

The problem link display area 613 displays an access destination for problem information PRJ. The problem information PRJ indicates a problem PR corresponding to the answer AN indicated by the answer image information MAJ for which access destination is displayed in the answer link display area 612. The access destination for the problem information PRJ is equivalent to “second link information”. When the user touches the problem link display area 613, the smartphone 300 acquires the problem information PRJ from the image forming apparatus 100 and displays an image representing the problem information PRJ on the touch panel.

Specifically, when the text data cannot be generated through the character recognition processing, the notification section 504 transmits to the smartphone 300 second link information LN2 that indicates the access destination for the problem information PRJ. The problem information PRJ indicates the problem PR corresponding to the answer AN for which it is determined that the text data cannot be generated. The smartphone 300 displays an image representing the second link information LN2 in the problem link display area 613.

The suggested answer link display area 614 displays an access destination for suggested answer information ASJ. The suggested answer information ASJ indicates a suggested answer AS corresponding to the answer AN indicated by the answer image information MAJ for which access destination is displayed in the answer link display area 612. The access destination for the suggested answer information ASJ is equivalent to “third link information”. When the user touches the suggested answer link display area 614, the smartphone 300 acquires the suggested answer information ASJ from the image forming apparatus 100 and displays an image representing the suggested answer information ASJ on the touch panel.

Specifically, when the text data cannot be generated through the character recognition processing, the notification section 504 transmits to the smartphone 300 third link information LN3 that indicates the access destination for the suggested answer information ASJ. The suggested answer information ASJ indicates the suggested answer AS corresponding to the answer AN for which it is determined that the text data cannot be generated. The smartphone 300 displays an image representing the third link information LN3 in the suggested answer link display area 614.

The second message display area 615 displays a message for requesting the user of the smartphone 300 to mark the answer AN correct or incorrect. Specifically, the following message “touch ∘ if the answer is correct, and touch × if the answer is incorrect” is displayed in the second message display area 615 to request the user of the smartphone 300 to mark the answer AN by touching either “∘” or “×”.

The state display area 616 displays a state of the first display area 610. Specifically, the state display area 616 displays a date on which the access destinations for the answer image information MAJ, the problem information PRJ, and the suggested answer information ASJ are received from the image forming apparatus 100 and information indicating whether or not the user of the smartphone 300 has replied. The date is for example “October 15” and the information indicating whether or not the user has replied is for example “replied”.

The second display area 620 displays matter similar to that displayed in the first display area 610. That is, the second display area 620 includes a first message display area 621, an answer link display area 622, a problem link display area 623, a suggested answer link display area 624, a second message display area 625, and a state display area 626.

Unlike the first display area 610, the second display area 620 indicates that the user of the smartphone 300 has not replied. That is, “not replied” is displayed in the state display area 626.

The first display area 610 and the second display area 620 differ from each other in color of display for the purpose of indicating that the user has replied to the message displayed in the first display area 610 and has not replied to the message displayed in the second display area 620. For example, the first display area 610 is displayed in black and the second display area 620 is displayed in red. The difference in color of display is indicated in FIG. 6 by surrounding the first display area 610 with a dash line and surrounding the second display area 620 with a solid line.

As described above with reference to FIGS. 1 to 6, the notification section 504 transmits to the smartphone 300 the first link information LN1 that indicates the access destination for the answer image information MAJ in the embodiment of the present disclosure. The answer image information MAJ indicates the answer image MA of the answer AN for which it is determined that the text data cannot be generated. Therefore, the user of the smartphone 300 can determine whether the answer AN is correct or incorrect on the basis of the answer image MA of the answer AN and transmit a result of the determination to the image forming apparatus 100. Through the above, even when the text data cannot be generated from the answer image MA through the character recognition processing, the answer AN can be marked on the basis of the result of the determination received from the smartphone 300.

Also, the notification section 504 transmits to the smartphone 300 the second link information LN2 that indicates the access destination for the problem information PRJ. The problem information PRJ corresponds to the answer AN for which it is determined that the text data cannot be generated. Therefore, the user of the smartphone 300 can properly determine whether the answer AN is correct or incorrect on the basis of the problem information PRJ.

Further, the notification section 504 transmits to the smartphone 300 the third link information LN3 that indicates the access destination for the suggested answer information ASJ corresponding to the answer AN for which it is determined that the text data cannot be generated. Therefore, the user of the smartphone 300 can further quickly and properly determine whether the answer AN is correct or incorrect on the basis of the suggested answer information ASJ.

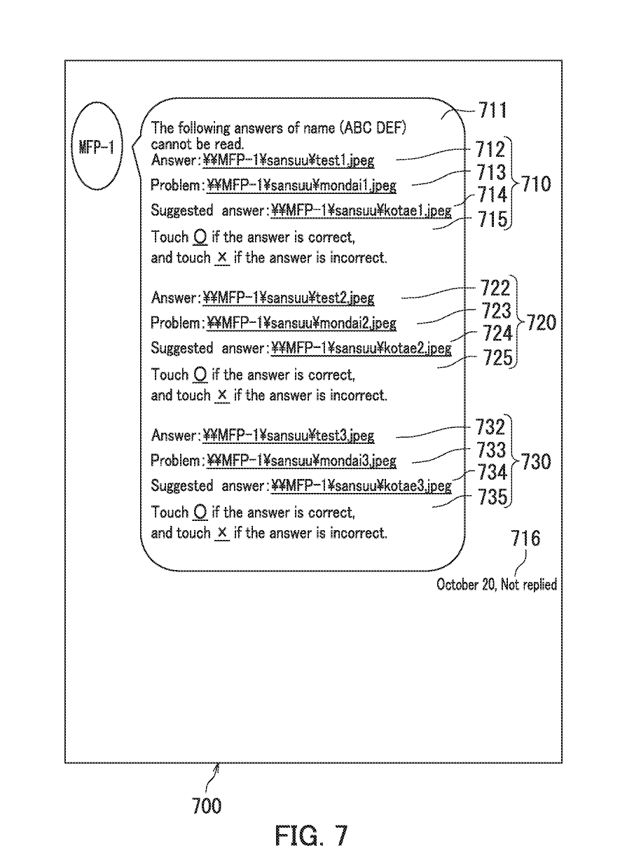

The following describes with reference to FIGS. 1 to 7 a notification screen 700 other than that illustrated in FIG. 6. FIG. 7 is a screen diagram illustrating the notification screen 700 other than that illustrated in FIG. 6. The notification screen 700 differs from the notification screen 600 illustrated in FIG. 6 in that plural pieces of first link information LN1 associated with the same answerer are collectively displayed in the notification screen 700.

The notification screen 700 includes a first message display area 711, a first display area 710, a second display area 720, a third display area 730, and a state display area 716. The first display area 710 includes an answer link display area 712, a problem link display area 713, a suggested answer link display area 714, and a second message display area 715.

The first message display area 711 displays a message for notifying the user of the smartphone 300 that plural answers AN of the same answerer cannot be marked. Specifically, the following message “the following answers of name (ABC DEF) cannot be read” is displayed in the first message display area 711, indicating that text data cannot be generated through the character recognition processing for the plural answers AN of the answerer named “ABC DEF”. The plural answers AN are for example three answers AN.

The answer link display area 712 displays an access destination for answer image information MAJ that indicates one of answer images MA of which text data cannot he generated through the character recognition processing. The access destination for the answer image information MAJ is equivalent to the “first link information”. When the user touches the answer link display area 712, the smartphone 300 acquires the answer image information MAJ from the image forming apparatus 100 and displays the answer image MA on the touch panel.

The problem link display area 713 displays an access destination for problem information PRJ. The problem information PRJ indicates a problem PR corresponding to an answer AN indicated by the answer image information MAJ for which access destination is displayed in the answer link display area 712. The access destination for the problem information PRJ is equivalent to the “second link information”. When the user touches the problem link display area 713, the smartphone 300 acquires the problem information PRJ from the image forming apparatus 100 and displays an image representing the problem information PRJ on the touch panel.

The suggested answer link display area 714 displays an access destination for suggested answer information ASJ. The suggested answer information ASJ indicates a suggested answer AS corresponding to the answer AN indicated by the answer image information MAJ for which access destination is displayed in the answer link display area 712. The access destination for the suggested answer information ASJ is equivalent to the “third link information”. When the user touches the suggested answer link display area 714, the smartphone 300 acquires the suggested answer information ASJ from the image forming apparatus 100 and displays an image representing the suggested answer information ASJ on the touch panel.

The second message display area 715 displays a message for requesting the user of the smartphone 300 to mark the answer AN correct or incorrect. Specifically, the following message “touch ∘ if the answer is correct, and touch × if the answer is incorrect” is displayed in the second message display area 715 to request the user of the smartphone 300 to mark the answer AN by touching either “∘” or “×”.

The second display area 720 and the third display area 730 display matter similar to that displayed in the first display area 710. That is, the second display area 720 includes an answer link display area 722, a problem link display area 723, a suggested answer link display area 724, and a second message display area 725. The third display area 730 includes an answer link display area 732, a problem link display area 733, a suggested answer link display area 734, and a second message display area 735. Note that the first display area 710, the second display area 720, and the third display area 730 correspond to respective answers AN different from one another.

The notification section 504 collectively transmits to the smartphone 300 the plural pieces of first link information LN1 corresponding to plural pieces of answer image information MAJ associated with the same answerer identification information AID. The answerer identification information AID is information on the name of the answerer in the embodiment of the present disclosure. The plural pieces of answer image information MAJ are for example three pieces of answer image information MAJ. More specifically, the notification section 504 collectively transmits to the smartphone 300 the second link information LN2, the third link information LN3, and the plural pieces of first link information LN1 corresponding to respective three pieces of answer image information MAJ associated with the same answerer identification information AID.

The state display area 716 displays a state of the first through third display areas 710, 720, and 730. Specifically, the state display area 716 displays a date on which the access destinations for the answer image information MAJ, the problem information PRI, and the suggested answer information ASJ are received from the image forming apparatus 100 and information indicating whether or not the user of the smartphone 300 has replied. The date is for example “October 20” and the information indicating whether or not the user has replied is for example “not replied”.

As described above with reference to FIGS. 1 to 7, the notification section 504 collectively transmits to the smartphone 300 the plural pieces of first link information LN1 associated with the same answerer in the embodiment of the present disclosure. The plural pieces of first link information LN1 correspond to the respective pieces of answer image information MAJ associated with the same answerer identification information AID. Thus, the plural pieces of first link information LN1 associated with the same answerer can be collectively transmitted to the smartphone 300. As a result, the plural pieces of first link information LN1 associated with the same answerer can be collectively displayed on the touch panel of the smartphone 300 to enable the user of the smartphone 300 to further quickly determine whether the answers AN are correct or incorrect.

Also, the notification section 504 collectively transmits to the smartphone 300 the plural pieces of first link information LN1, plural pieces of second link information LN2, and plural pieces of third link information LN3 that are each associated with the same answerer. The plural pieces of second link information LN2 correspond to plural pieces of problem information PRJ associated with the same answerer identification information AID. The plural pieces of third link information LN3 correspond to plural pieces of suggested answer information ASJ associated with the same answerer identification information AID. Therefore, the user of the smartphone 300 can further quickly and properly determine whether the plural answers AN are correct or incorrect on the basis of the respective pieces of problem information PRJ and the respective pieces of suggested answer information ASJ.

Although the notification section 504 collectively transmits to the smartphone 300 the plural pieces of first link information LN1 corresponding to the plural pieces of answer image information MAJ associated with the same answerer identification information AID, the second link information LN2, and the third link information LN3 in the embodiment of the present disclosure as described above with reference to FIGS. 1 to 7, the present disclosure is not limited thereto. It is only required that the notification section 504 collectively transmits to the smartphone 300 the plural pieces of first link information LN1 associated with the same answerer. For example, the notification section 504 may collectively transmit to the smartphone 300 the plural pieces of first link information LN1 and the plural pieces of third link information LN3 associated with the same answerer without transmitting the second link information LN2 to the smartphone 300. This configuration can reduce an amount of information transmitted from the image forming apparatus 100 to the smartphone 300.

Although the answerer identification information AID is the information on the name of the answerer in the embodiment of the present disclosure as described above with reference to FIGS. 1 to 7, the present disclosure is not limited thereto. It is only required that the answerer can be identified by the answerer identification information AID. The answerer identification information AID may for example be information on the name of a class to which the answerer belongs or information on a student number of the answerer in a class. In this configuration, the information on the name of the class or the information on the student number is represented by one or more alphabetic characters or a number. Therefore, it can be ensured that the character recognition section 502 generates the answerer identification information AID from the image information MJ.

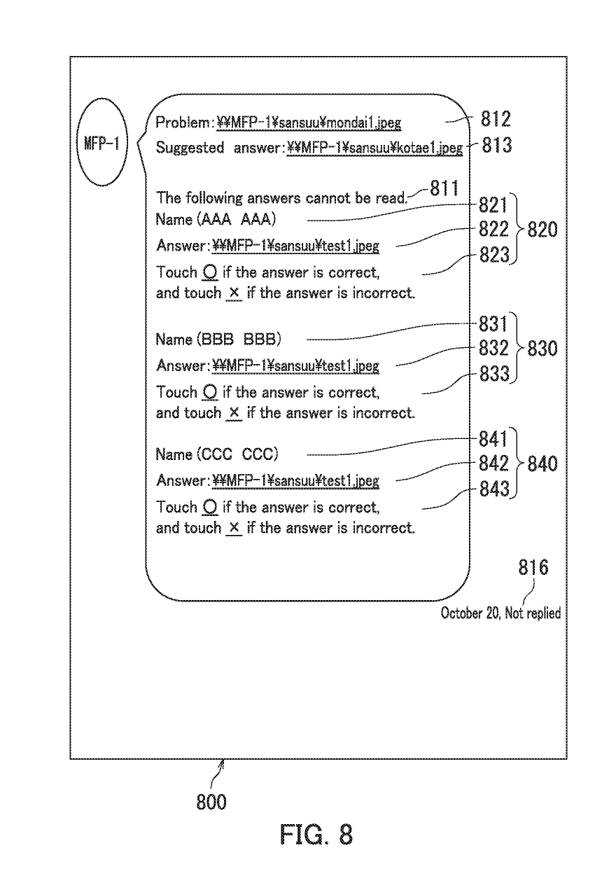

The following describes with reference to FIGS. 1 to 8 a notification screen 800 other than those illustrated in FIGS. 6 and 7. FIG. 8 is a screen diagram illustrating the notification screen 800 other than those illustrated in FIGS. 6 and 7. The notification screen 800 differs from the notification screen 600 illustrated in FIG. 6 and the notification screen 700 illustrated in FIG. 7 in that plural pieces of first link information LN1 associated with the same problem PR are collectively displayed on the notification screen 800.

The notification screen 800 includes a first message display area 811, a problem link display area 812, a suggested answer link display area 813, a first display area 820, a second display area 830, a third display area 840, and a state display area 816. The first display area 820 includes a third message display area 821, an answer link display area 822, and a second message display area 823.

The problem link display area 812 displays an access destination for problem information PRJ. The problem information PRJ indicates a problem PR corresponding to answers AN of which text data cannot be generated through the character recognition processing. The access destination for the problem information PRJ is equivalent to the “second link information”. When the user touches the problem link display area 812, the smartphone 300 acquires the problem information PRJ from the image forming apparatus 100 and displays an image representing the problem information PRJ on the touch panel.

The suggested answer link display area 813 displays an access destination for suggested answer information ASJ. The suggested answer information ASJ indicates a suggested answer AS corresponding to the answers AN of which text data cannot be generated through the character recognition processing. The access destination for the suggested answer information ASJ is equivalent to the “third link information”. When the user touches the suggested answer link display area 813, the smartphone 300 acquires the suggested answer information ASJ from the image forming apparatus 100 and displays an image representing the suggested answer information ASJ on the touch panel.

The first message display area 811 displays a message for notifying the user of the smartphone 300 that the answers AN of plural answerers to the same problem PR cannot be marked. Specifically, the following message “the following answers cannot be read” is displayed in the first message display area 811, indicating that text data cannot be generated through the character recognition processing for the answers AN of the plural answerers to the same problem PR. The problem PR is indicated by the problem information PRJ for which access destination is displayed in the problem link display area 812.

An image representing answerer identification information AID is displayed in the third message display area 821. Specifically, “name (AAA AAA)” is displayed in the third message display area 821, indicating that text data cannot be generated through the character recognition processing for an answer AN of an answerer named “AAA AAA”.

The answer link display area 822 displays an access destination for answer image information MAJ that indicates an answer image MA of which text data cannot be generated through the character recognition processing. The access destination for the answer image information MAJ is equivalent to the “first link information”. When the user touches the answer link display area 822, the smartphone 300 acquires the answer image information MAJ from the image forming apparatus 100 and displays the answer image MA on the touch panel.

The second message display area 823 displays a message for requesting the user of the smartphone 300 to mark the answer AN correct or incorrect. Specifically, the following message “touch ∘ if the answer is correct, and touch × if the answer is incorrect” is displayed in the second message display area 823 to request the user of the smartphone 300 to mark the answer AN by touching either “∘” or “×”.

The second display area 830 and the third display area 840 display matter similar to that displayed in the first display area 820. That is, the second display area 830 includes a third message display area 831, an answer link display area 832, and a second message display area 833. The third display area 840 includes a third message display area 841, an answer link display area 842, and a second message display area 843. Note that the first display area 820, the second display area 830, and the third display area 840 correspond to the respective answers AN of the plural answerers.

Specifically, the notification section 504 collectively transmits to the smartphone 300 the plural pieces of first link information LN1 corresponding to plural pieces of answer image information MAJ associated with the same problem identification information PID. More specifically, the notification section 504 collectively transmits to the smartphone 300 the plural pieces of first link information LN1 corresponding to the plural pieces of answer image information MAJ associated with the same problem identification information PID, the second link information LN2, and the third link information LN3.

The state display area 816 displays a state of the first through third display areas 820, 830, and 840. Specifically, the state display area 816 displays a date on which access destinations for the respective pieces of answer image information MAJ are received from the image forming apparatus 100 and information indicating whether or not the user of the smartphone 300 has replied. The date is for example “October 20” and the information indicating whether or not the user has replied is “not replied”.

As described above with reference to FIGS. 1 to 8, the notification section 504 collectively transmits to the smartphone 300 the plural pieces of first link information LN1 associated with the same problem PR in the embodiment of the present disclosure. The plural pieces of first link information LN1 correspond to the plural pieces of answer image information MAJ associated with the same problem identification information PID. Therefore, the plural pieces of first link information LN1 corresponding to the respective answers AN of the plural answerers to the same problem PR can be collectively transmitted to the smartphone 300. As a result, the plural pieces of first link information LN1 associated with the same problem PR can be collectively displayed on the touch panel of the smartphone 300 to enable the user of the smartphone 300 to further quickly determine whether the answers AN are correct or incorrect.

Also, the notification section 504 collectively transmits to the smartphone 300 the plural pieces of first link information LN1 corresponding to the respective answers AN to the same problem PR, the second link information LN2, and the third link information LN3. The second link information LN2 corresponds to the problem information PRJ of the problem PR. The third link information LN3 corresponds to the suggested answer information ASJ corresponding to the problem PR. Therefore, the user of the smartphone 300 can further quickly and properly determine whether the answers AN are correct or incorrect on the basis of the problem information PRJ and the suggested answer information ASJ.

Although the notification section 504 transmits to the smartphone 300 the plural pieces of first link information LN1 corresponding to the respective answers AN of the plural answerers to the same problem PR, the second link information LN2, and the third link information LN3 in the embodiment of the present disclosure as described above with reference to FIGS. 1 to 8, the present disclosure is not limited thereto. It is only required that the notification section 504 collectively transmits to the smartphone 300 the plural pieces of first link information LN1 corresponding to the respective answers AN of the plural answerers to the same problem PR. For example, the notification section 504 may transmit to the smartphone 300 the plural pieces of first link information LN1 and the third link information LN3 without transmitting the second link information LN2 to the smartphone 300. This configuration can reduce an amount of information transmitted from the image forming apparatus 100 to the smartphone 300.

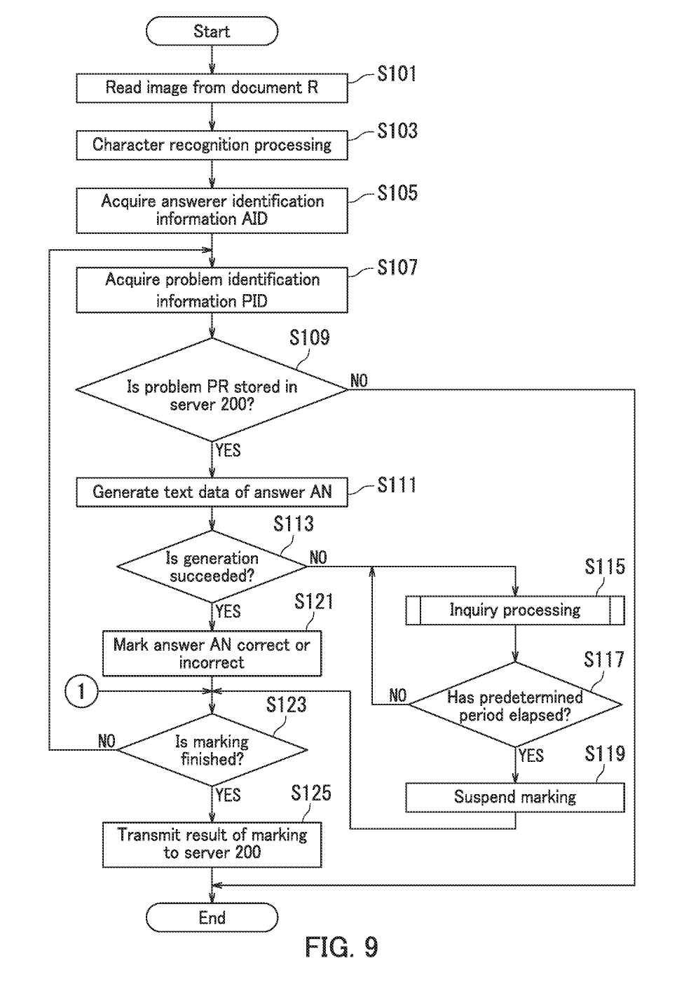

The following describes processing performed by the controller 5 with reference to FIGS. 1 to 9. FIG. 9 is a flowchart illustrating an example of the processing performed by the controller 5.

As illustrated in FIG. 9, the reading section 501 reads an image from the document R and generates image information MJ at step S101. An answer AN to a problem PR is entered on the document R,

Next at step S103, the character recognition section 502 performs the character recognition processing on the image information MJ and generates text data ANJ corresponding to the answer AN.

At step S105, the acquisition section 503 acquires answerer identification information AID. Specifically, the acquisition section 503 acquires the answerer identification information AID on the basis of image information indicating a name included in the image information MJ.

At step S107, the acquisition section 503 acquires problem identification information PID. Specifically, the acquisition section 503 acquires the problem identification information PID on the basis of an image of a problem identification code included in the image information MJ.

At step S109, the controller 5 determines whether or not the problem PR is stored in the server 200. Specifically, the controller 5 determines on the basis of the problem identification information PID whether or not the problem PR is identical with any of plural problems PR stored in the server 200.

When the controller 5 determines that the problem PR is not stored in the server 200 (NO at step S109), the processing ends. When the controller 5 determines that the problem PR is stored in the server 200 (YES at step S109), the processing proceeds to step S111.

At step S111, the character recognition section 502 performs the character recognition processing on the image information MJ and generates text data ANJ corresponding to the answer AN.

At step S113, the character recognition section 502 determines whether or not generation of the text data ANJ is succeeded.

When the character recognition section 502 determines that generation of the text data ANJ is succeeded (YES at step S113), the processing proceeds to step S121. When the character recognition section 502 determines that generation of the text data ANJ is not succeeded (NO at step S113), the processing proceeds to step S115.

At step S115, the controller 5 performs “inquiry processing”. The “inquiry processing” is processing by the controller 5 inquiring of the smartphone 300 whether the answer AN is correct or incorrect.

At step S117, the controller 5 determines whether or not a predetermined period has elapsed from the start of the “inquiry processing”. The predetermined period is for example five minutes.

When the controller 5 determines that the predetermined period has not elapsed (NO at step S117), the processing returns to step S115. When the controller 5 determines that the predetermined period has elapsed (YES at step S117), the processing proceeds to step S119.

At step S119, the controller 5 suspends marking of the answer AN, and the processing proceeds to step S123.

When the determination at step S113 is positive, the marking section 505 marks the answer AN on the basis of the text data ANJ at step S121.

At step S123, the controller 5 determines whether or not marking of all answers AN is finished.

When the controller 5 determines that marking of all the answers AN is not finished (NO at step S123), the processing returns to step S107. When the controller 5 determines that marking of all the answers AN is finished (YES at step S123), the processing proceeds to step S125.

At step S125, the controller 5 transmits results of the marking to the server 200, and the processing ends then.

As described above with reference to FIGS. 1 to 9, the controller 5 suspends marking of the answer AN when the predetermined period has elapsed from the start of the “inquiry processing” in the embodiment of the present disclosure. Therefore, even when generation of the text data ANJ of the answer AN is not succeeded, another answer AN can be marked. Through the above, marking can be performed efficiently.

When the controller 5 suspends marking of an answer AN, it is preferable to check at specific time intervals (for example, at every five minutes) whether or not a reply about the answer AN is received from the smartphone 300. When a reply is received from the smartphone 300, the answer AN can be marked.

The following describes the “inquiry processing” with reference to FIGS. 1 to 10, FIG. 10 is a flowchart illustrating an example of the “inquiry processing” performed by the controller 5.

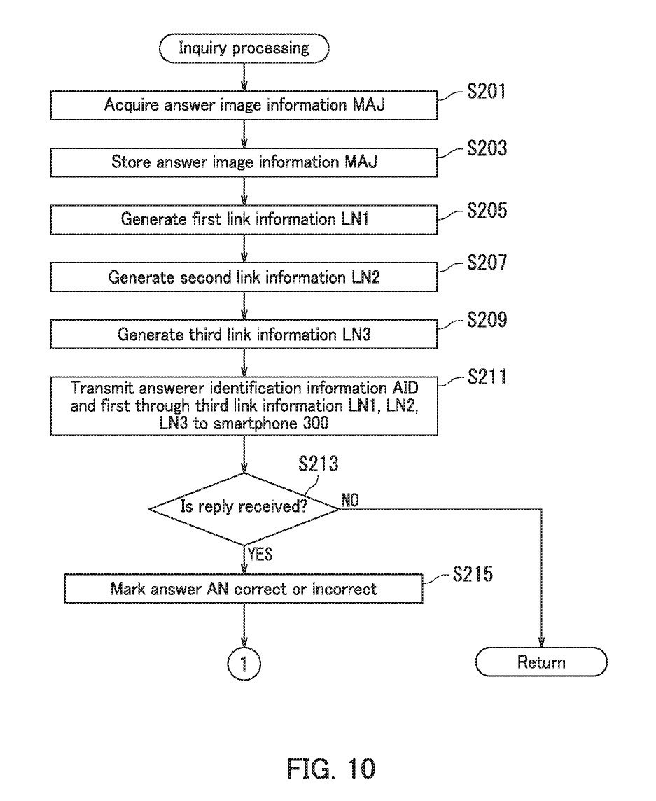

As illustrated in FIG. 10, the controller 5 initially acquires the answer image information MAJ at step S201. Specifically, the controller 5 acquires as the answer image information MAJ an image of a region where the answer AN is entered on the basis of the image information MJ.

At step S203, the controller 5 stores the answer image information MAJ in the storage 5B.

At step S205, the controller 5 generates the first link information LN1. The first link information indicates an access destination for the answer image information MAJ.

At step S207, the controller 5 generates the second link information LN2. The second link information LN2 indicates an access destination for the problem information PRJ.

At step S209, the controller 5 generates the third link information LN3. The third link information LN3 indicates an access destination for the suggested answer information ASJ.

At step S211, the notification section 504 transmits the answerer identification information AID, the first link information LN1, the second link information LN2, and the third link information LN3 to the smartphone 300.

At step S213, the marking section 505 determines whether or not a reply is received from the smartphone 300.

When the marking section 505 determines that no reply is received from the smartphone 300 (NO at step S213), the processing returns to step S117 in FIG. 9. When the marking section 505 determines that a reply is received from the smartphone 300 (YES at step S213), the processing proceeds to step S215.

At step S215, the marking section 505 marks the answer AN on the basis of the reply from the smartphone 300, and the processing proceeds to step S123 in FIG. 9.

As described above with reference to FIGS. 1 to 10, the marking section 505 receives a reply from the smartphone 300 and marks the answer AN on the basis of the reply in the embodiment of the present disclosure. Therefore, by receiving for example information indicating whether the answer AN is correct or incorrect from the user of the smartphone 300, the answer AN can be easily marked on the basis of the reply.

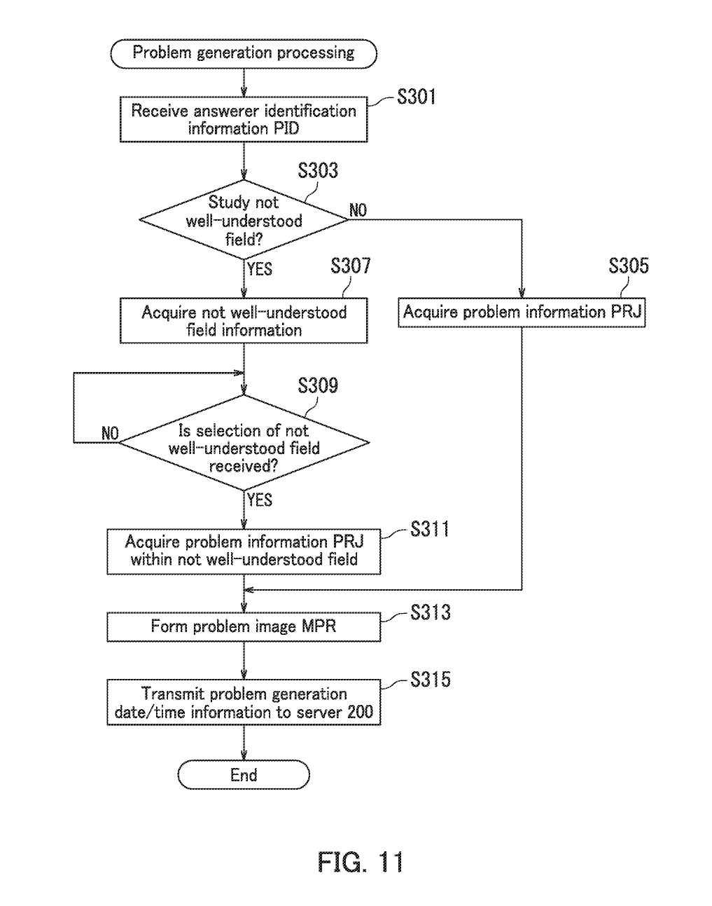

The following describes “problem generation processing” with reference to FIGS. 1 to 11. FIG. 11 is a flowchart illustrating an example of the “problem generation processing” performed by the controller 5. The “problem generation processing” is processing for forming a problem image MPR on paper P in response to an operation by a user (for example, a student).

As illustrated in FIG. 11, the controller 5 initially receives the answerer identification information AID in response to an operation by the user on the touch panel 41 at step S301.

At step S303, the controller 5 determines whether or not to form on the paper P the problem image MPR to be used for study for a not well-understood field on the basis of an operation by the user on the touch panel 41.

When the controller 5 determines not to form on the paper P the problem image MPR to be used for study for the not well-understood field (NO at step S303), the processing proceeds to step S305.

At step S305, the controller 5 acquires the problem information PRJ from the server 200 on the basis of the answerer identification information AID, and the processing proceeds to step S313.

When the controller 5 determines to form on the paper P the problem image MPR to be used for study for the not well-understood field (YES at step S303), the processing proceeds to step S307.

At step S307, the controller 5 acquires not well-understood field information from the server 200 on the basis of the answerer identification information AID and displays an image representing the not well-understood field on the touch panel 41.

At step S309, the controller 5 determines whether or not selection of the not well-understood field is received on the basis of an operation by the user on the touch panel 41.

When the controller 5 determines that selection of the not well-understood field is not received (NO at step S309), the processing is suspended. When the controller 5 determines that selection of the not well-understood field is received (YES at step S309), the processing proceeds to step S311.

At step S311, the acquisition section 503 acquires from the server 200 problem information PRJ of a problem PR that belongs to the not well-understood field.

At step S313, the instruction section 508 instructs the image forming unit 1 to form the problem image MPR representing the problem information PRJ on the paper P.

At step S315, the controller 5 transmits problem generation date and time information to the server 200, and the processing ends then. The problem generation date and time information indicates a date and a time at which the problem image MPR representing the problem information PR:I is formed on the paper P.

As described above with reference to FIGS. 1 to 11, the acquisition section 503 acquires from the server 200 the problem information PRJ indicating the problem PR that belongs to the not well-understood field and the image forming unit 1 forms the problem image MPR representing the acquired problem information PRJ on the paper P in the embodiment of the present disclosure. Thus, the image of the problem PR belonging to the not well-understood field can be formed on the paper P to be used by an answerer for study for the not well-understood field.

Through the above, the embodiment of the present disclosure has been described with reference to the drawings. However, the present disclosure is not limited to the above embodiment and may be practiced in various manners within a scope not departing from the gist of the present disclosure (for example, as described below in sections (1) and (2)). The drawings schematically illustrate elements of configuration in order to facilitate understanding thereof, and properties of the elements of configuration illustrated in the drawings such as the thickness, the length, and the number thereof may differ from actual properties thereof in order to facilitate preparation of the drawings. Also, the shape, dimensions, and the like of elements of configuration described in the above embodiment are merely examples and not intended as specific limitations. Various alterations may be made within a scope not substantially departing from the configuration of the present disclosure.

(1) Although the image reading device described with reference to FIGS. 1 to 3 is included in the image forming apparatus 100, the present disclosure is not limited thereto. It is only required that the image reading device includes at least the document reader 2 and the controller 5. It is preferable that the image reading device further includes the document conveyance unit 3. In this configuration, the document reader 2 is capable of reading the document R conveyed by the document conveyance unit 3. Further, it is preferable that the image reading device includes the operation display section 4.

(2) Although the problem spaces 551 to 553 are printed on the answer sheet 550 as described with reference to FIGS. 1 to 5, the present disclosure is not limited thereto. It is only required that the name space 560 and the answer spaces 561 to 563 are printed on the answer sheet 550.

What is claimed is:

1. An image reading device comprising:
a reading section configured to read an image from a document on which an answer to a problem is entered and generate image information;
a character recognition section configured to perform character recognition processing on the image information and generate text data corresponding to the answer;
a marking section configured to mark the answer on the basis of the text data; and
a notification section configured to notify a specific terminal device that the answer cannot be marked when the text data cannot be generated through the character recognition processing.

2. The image reading device according to claim 1, wherein
when the text data cannot be generated through the character recognition processing, the notification section transmits to the specific terminal device first link information that indicates an access destination for answer image information, and
the answer image information indicates an image of the answer for which it is determined that the text data cannot be generated.

3. The image reading device according to claim 2, wherein
a problem identification image representing identification information of the problem is formed on each of plural sheets of the document,
an answer to the problem is entered on each of the plural sheets of the document,
the reading section reads images from the plural sheets of the document and generates plural pieces of the image information,
the character recognition section performs the character recognition processing on the plural pieces of the image information and generates the identification information of the problem corresponding to the problem identification image, and
the notification section collectively transmits to the specific terminal device plural pieces of the first link information corresponding to plural pieces of the answer image information, the plural pieces of the answer image information being associated with the identification information of the problem.

4. The image reading device according to claim 2, wherein
an answerer identification image representing identification information of an answerer is formed on each of plural sheets of the document,
an answer to a problem is entered on each of the plural sheets of the document, the answer to the problem being entered by the answerer,
the reading section reads images from the plural sheets of the document and generates plural pieces of the image information,
the character recognition section performs the character recognition processing on the plural pieces of the image information and generates the identification information of the answerer corresponding to the answerer identification image, and
the notification section collectively transmits to the specific terminal device plural pieces of the first link information corresponding to plural pieces of the answer image information, the plural pieces of the answer image information being associated with the identification information of the answerer.

5. The image reading device according to claim 4, wherein
the specific terminal device includes a display, and
the notification section controls the specific terminal device to collectively display on the display the plural pieces of the first link information corresponding to the plural pieces of the answer image information associated with the identification information of the answerer.

6. The image reading device according to claim 2, wherein
when the text data cannot be generated through the character recognition processing, the notification section transmits to the specific terminal device second link information that indicates an access destination for problem information, and
the problem information indicates a problem corresponding to the answer for which it is determined that the text data cannot be generated.

7. The image reading device according to claim 6, further comprising
a first acquisition section configured to acquire the problem information from a server, wherein
a problem identification image representing identification information of the problem is formed on the document,
the character recognition section performs the character recognition processing on the image information and generates the identification information of the problem corresponding to the problem identification image,
the first acquisition section acquires the problem information from the server on the basis of the identification information of the problem, and
the notification section transmits to the specific terminal device the problem information acquired by the first acquisition section.

8. The image reading device according to claim 2, wherein
when the text data cannot be generated through the character recognition processing, the notification section transmits to the specific terminal device third link information that indicates an access destination for suggested answer information, and
the suggested answer information indicates a suggested answer corresponding to the answer for which it is determined that the text data cannot he generated.

9. The image reading device according to claim 8, further comprising
a second acquisition section configured to acquire the suggested answer information from a server, wherein
a problem identification image representing identification information of the problem is formed on the document,
the reading section reads the image from the document and generates age information,
the character recognition section performs the character recognition processing on the image information and generates the identification information of the problem corresponding to the problem identification image,
the second acquisition section acquires the suggested answer information from the server on the basis of the identification information of the problem, and
the notification section transmits to the specific terminal device the suggested answer information acquired by the second acquisition section.

10. The image reading device according to claim 1, wherein
the marking section receives a reply from the specific terminal device and marks the answer on the basis of the reply.

11. An image forming apparatus comprising:
a reading section configured to read an image from a document on which an answer to a problem is entered and generate image information;
a character recognition section configured to perform character recognition processing on die image information and generate text data corresponding to the answer;
a marking section configured to mark the answer on the basis of the text data;
a notification section configured to notify a specific terminal device that the answer cannot be marked when the text data cannot be generated through the character recognition processing; and
an image forming device configured to form an image on a recording medium.

12. The image forming apparatus according to claim 11, further comprising:
a measurement section configured to measure an answer period that indicates a period of time from when an answerer starts answering to when the answerer finishes answering;
a determination section configured to determine a well-understood field and a not well-understood field on the basis of the answer period and a correct answer rate, the correct answer rate indicating a probability that the answer is correct; and
a third acquisition section configured to acquire from a server problem information that indicates a problem belonging to the not well-understood field, wherein
the image forming device forms a problem image on the recording medium, the problem image representing the problem information acquired by the third acquisition section.

13. An image reading system comprising an image reading device and a server communicatively connected to the image reading device, wherein
the image reading device includes:
a reading section that reads an image from a document on which an answer to a problem is entered and generate image information;
a character recognition section that performs character recognition processing on the image information and generate text data corresponding to the answer;
a marking section that marks the answer on the basis of the text data;
a notification section that notifies a specific terminal device that the answer cannot be marked when the text data cannot he generated through the character recognition processing; and
a first acquisition section that acquires problem information from the server,
the problem information indicates a problem corresponding to the answer for which it is determined that the text data cannot be generated, and
the notification section transmits to the specific terminal device the problem information acquired by the first acquisition section.
